(19) United States
(12) Patent Application Publication
(10) Pub. No.: US 2015/0294263 A1
(43) Pub. Date: Oct. 15, 2015

(54) SHIP PERFORMANCE ANALYSIS AND LOG MANAGEMENT

(71) Applicants: RAJESH UNNI, Chennai (IN); Swaminathan Hariharaputhran, Chennai (IN); Gautam Kar, Chennai (IN); Shivram Volety, Chennai (IN); Sivakumar Kattumpurath Hariharakumar, Ernakulam (IN); Sunil George, Ernakulam (IN); Sudeesh Kizhakkepurakkal Balakrishnan, Thrissur (IN); Sumesh Somasekharan Pillai, Trivandrum (IN)

(72) Inventors: RAJESH UNNI, Chennai (IN); Swaminathan Hariharaputhran, Chennai (IN); Gautam Kar, Chennai (IN); Shivram Volety, Chennai (IN); Sivakumar Kattumpurath Hariharakumar, Ernakulam (IN); Sunil George, Ernakulam (IN); Sudeesh Kizhakkepurakkal Balakrishnan, Thrissur (IN); Sumesh Somasekharan Pillai, Trivandrum (IN)

(73) Assignee: LULJETA LTD., Singapore (SG)

(21) Appl. No.: 14/686,795

(22) Filed: Apr. 15, 2015

(30) Foreign Application Priority Data
Apr. 15, 2014 (IN) 1945/CHE/2014

(51) Int. Cl. G06Q 10/08; G06Q 10/06; G06Q 10/10; H04L 29/08

(52) U.S. Cl. CPC G06Q 10/083; H04L 67/12; G06Q 10/0631; G06Q 10/087; G06Q 10/1097

(57) ABSTRACT

A system for management of operations of one or more vessels is disclosed, comprising a land-based server coupled to one or more business databases, wherein the business databases comprises business data including financial data and inventory data, a vessel-based server coupled to one or more sensor modules configured to collect voyage related data; and a contextual engine coupled to the land-based server and the vessel-based server via a network. The contextual engine is configured to synchronize the voyage data and the business data, and produces a context specific management framework using the synchronized voyage data and the business data.

### RELATED APPLICATION

This application claims benefit and priority to Indian Patent Application No. 1945/CHE/2014, entitled “SHIP PERFORMANCE ANALYSIS AND LOG MANAGEMENT”, filed on Apr. 15, 2014. The disclosure of that India application is incorporated herein by reference for all purposes.

### BACKGROUND

Present disclosure generally relates to a system for managing cargo ships and shipping fleets, and in particular to an integrated system including software for managing activities related to shipping, as well as operation of ships, other than the actual running or navigation of the ship.

Shipping management involves many stakeholders such as fleet owners, ship managers, charterers or customers and brokers, who need to remain in communication in order to effect smooth transport of goods and effective utilization of capacity. Each stakeholder has different requirements—for example, fleet owners would like to book capacity and schedule the movement of vessels efficiently in a planned manner. Customers would like to have information as to availability of space, scheduled departure of various sized vessels, unit cost, etc. in easily accessible format. Brokers are a special class of customer who would like to have access to vessel availability, schedules and costs so that they could offer customized logistic solutions at smaller scales, offering grouping of requirements from retail customers, etc. Ship operators and ship managers need to interact with owners and customers in real time to effectively meet their respective objectives as outlined above.

Operation of ships involves many processes such as operations management, technical management, financial management, etc. Operations management includes management of the voyage, dry docking and commercial activities, technical management may involve crewing, safety, security, repairs, purchasing and inventory, risk management etc. and financial management involves budget controls, multi-currency capabilities, integration with existing software packages, pool and disbursement management.

Other functional features desirable in a system for managing ships is the ability to maintain credentials such as safety certificates, personnel licenses, quality information etc. Another desirable feature is the automatic direction of tasks to responsible persons in a sequential or simultaneous manner, as the task may. There is a need for an integrated software package to provide all the above functions.

Existing software packages do not provide all the functions as described above and the user is forced to install more than one package from various providers that may or may not be compatible with each other. Such packages are disclosed in patent publications such as US20080147257A1 and US20100191565A1, or in software packages offered by entities such as ShipNet, Danas Information Services, etc.

The invention is directed to devices and methods for management of shipping activities including operational, safety, technical and engineering and financial aspects of ship and fleet management.

### SUMMARY

Described herein are systems and methods for management of operations of one or more vessels of a shipping fleet. In one embodiment, the system comprises a land-based server coupled to one or more business databases, wherein the business databases comprise business data including financial data and inventory data, a vessel-based server coupled to one or more sensor modules configured to collect voyage related data, and a contextual engine coupled to the land-based server and the vessel-based server via a network. The contextual engine is configured to synchronize the voyage data and the business data; and wherein the contextual engine is configured to produce a context specific management framework using the synchronized voyage data and the business data. The system may further comprise a regulation server coupled to one or more regulation databases comprising vessel regulation data, docking data and vessel certification data.

In one embodiment of the system the management framework is presented as a dashboard. The vessel-based and land-based servers of the system further comprise workflow-based modules for management of operations of a vessel including a quality, health, safety and environmental compliance module, a voyage management module, a crew management module, a purchase and inventory management module, and an administration module. The modules are configured to provide workflow based functions and communication through a network. In various embodiments, the communication is effected via a satellite network, a Wi-Fi network, a mobile telephone network or a wired data network.

In one embodiment the land-based server further comprises a finance module, a commercial and logistics module, a document management system, and a planned maintenance system, wherein the modules are configured for managing a fleet of vessels.

The quality, health, safety and environmental compliance module of the system is configured to perform functions comprising recording of accidents, scheduling and recording of audits, scheduling and reviewing of drills, scheduling and conducting investigations, including reviewing and implementing corrective actions thereafter, scheduling and communicating of meetings and capturing minutes thereof, scheduling of training, risk assessment and scenario analysis. The quality, health, safety and environmental compliance module is further configured to perform functions including generating reporting and communication corresponding to each function.

In one embodiment of the system the voyage module is configured to perform the functions of scheduling of voyages, logging of voyage details including ship's position, bunker details, garbage details and cargo details, reporting of bunker details, departures, noon reports and arrivals, and geo-location of one or more ships.

In one embodiment of the system the crew management module is configured to perform the functions of recording and maintaining a crew database, tracking of sign-on and sign-off dates of crew in the database, searching and retrieving crew availability data, maintenance of crew contract data, recording performance appraisal of crew, and administering a promotion system based on the appraisal. The crew management module may further comprise a training and repatriation module for follow up actions based on the appraisal data.

In one embodiment of the system the purchase module comprises a shopping module configured to handle purchase requests, an inventory management module operable with the inventory database and an ordering module operable with a vendor database to send enquiries, receive offers and prepare comparative statements.

In one embodiment of the system the administration module further comprises a workflow engine configured to administer user privileges for authorizing transactions and approvals within the system, and to provide alerts for follow-up of incomplete tasks according to the workflow.

In one embodiment the system of the invention further comprises a mobile application configured to provide to a user voyage related details and alerts based on role of the user.

In one embodiment the invention is a computer program product with program code for management of operations of one or more vessels, comprising a contextual engine connected to a land-based server and a vessel-based server via a network, the land-based server coupled to one or more business databases wherein the business databases comprise business data including financial data and inventory data. The vessel-based server is coupled to one or more sensor modules configured to collect voyage related data. The contextual engine is configured to synchronize data between the land based server and the vessel-based server and to produce a context specific management framework using the synchronized voyage data and the business data.

In one aspect the computer program product of the invention further comprises workflow-based modules for management of operations of a vessel including a quality, health, safety and environmental compliance module, a voyage management module, a crew management module, a purchase and inventory management module and an administration module, wherein, the modules are configured to provide workflow based functions and communication through a network. The communication is effected via a satellite network, a Wi-Fi network, a mobile telephone network or a wired data network.

Other aspects of the invention include corresponding compositions, methods, and systems are described herein.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a schematic diagram of the system of the invention.

FIG. 2 illustrates the functional modules used in the system.

FIG. 3 is a schematic showing the architecture of the system.

FIG. 4 shows the workflow definitions used by the system.

FIG. 5 is a diagram showing the communication protocol followed by the system.

FIG. 6 shows the dashboard of an instance of the application.

FIG. 7 is a screen showing vessel and voyage report list on a server instance.

FIG. 8 shows a typical certificate database on a server instance of the system.

FIG. 9 illustrates the document repository associated with a server instance of the system.

FIG. 10 is a screen illustrating work flow customization on the server instance of the system.

FIG. 11 shows an example of the communication service log of the system.

FIG. 12 shows a vessel instance of the system of the invention.

### DETAILED DESCRIPTION

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The word “exemplary” is used herein to mean “serving as an example, instance, or illustration.” Any implementation described herein as “exemplary” is not necessarily to be construed as advantageous over other implementations.

Although the detailed description contains many specifics, these should not be construed as limiting the scope of the invention but merely as illustrating different examples and aspects of the invention. It should be appreciated that the scope of the invention includes other embodiments not discussed herein. Various other modifications, changes and variations which will be apparent to those skilled in the art may be made in the arrangement, operation and details of the system and method of the present invention disclosed herein without departing from the spirit and scope of the invention as described here.

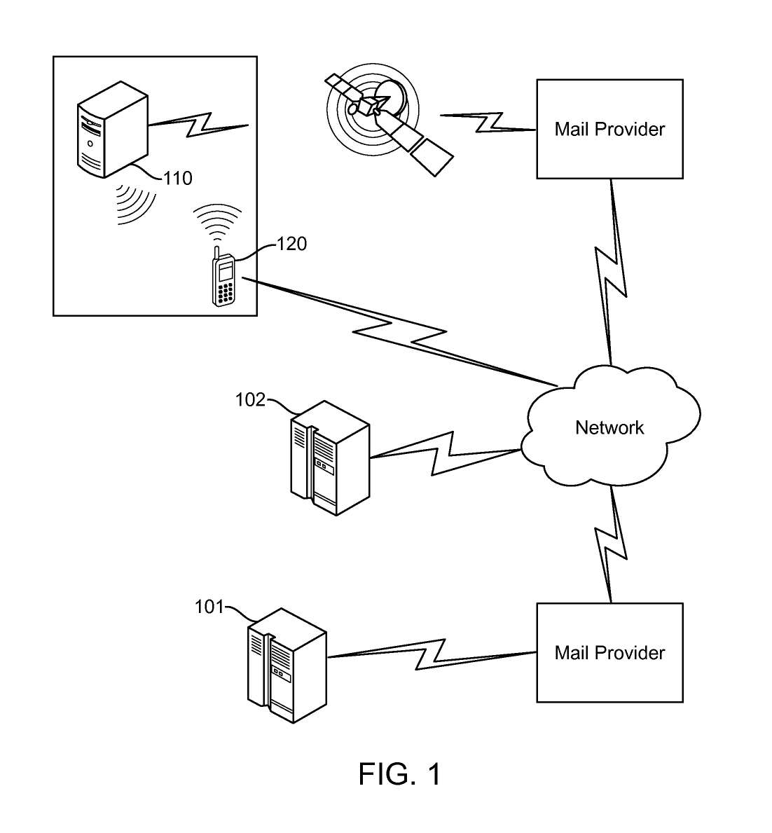

Embodiments of the present invention relate generally to a devices, methods, and systems for handling office as well as on-board ship management activities. The framework for the various embodiments of the invention is the system illustrated in FIG. 1, where land-based server 101 is in communication with a ship-based server 110 connected through a network. The framework additionally comprises handheld device 120, also connected to the network and/or directly to the server 110 as shown in FIG. 1. The connection between server 101 and server 110 may be facilitated by one or more intermediary agencies such as a mail provider, a satellite network provider or other communication network provider. In some embodiments the system of the invention provides a management framework presented to the user as a dashboard.

In one embodiment the central instance running on the land-based server 101 is coupled to voyage data from one or more sensors connected through a vessel 110 and one or more business databases including business data and financial data. The sensor data may comprise local time data, geolocation data such as longitude and latitude of the vessel's location, meteorological data including temperature, atmospheric pressure, precipitation, pressure change data, and so on. The business data may comprise financial data, unit cost data, personnel data, cargo data, bunkering data, schedule data including arrival and departure of vessels, weather data etc.

Additionally, server 101 may include various modules for providing information storage, analysis and retrieval such as a financial module, a technical module vessel maintenance data including vessel condition monitoring data, vessel registration information, vessel statutory reporting, vessel certification, dry docking, vessel efficiency/performance data and contingency plans. Additionally and optionally, a dedicated regulation server 102 may be located on land, for housing one or more regulation databases such as vessel regulation data, docking data and vessel certification data, as may be required. In various embodiments the land based server 101 is connected to the synchronized voyage data and the business data.

In one embodiment of the invention, the system runs in multiple instances—a central instance at office on server 101 and an instance in each ship on the vessel-based server 110. A mobile instance of the application is configured to run on handheld device 120. The mobile instance on 120 is configured to receive updates comprising voyage related data and alerts from vessel based server 110 via a network, including a local network such as a Wi-Fi based network. The system of the invention is configured to work either in online or offline mode, according to availability of networks. When working in the offline mode the system data is synchronized through the communication services, which send and receive the data as email.

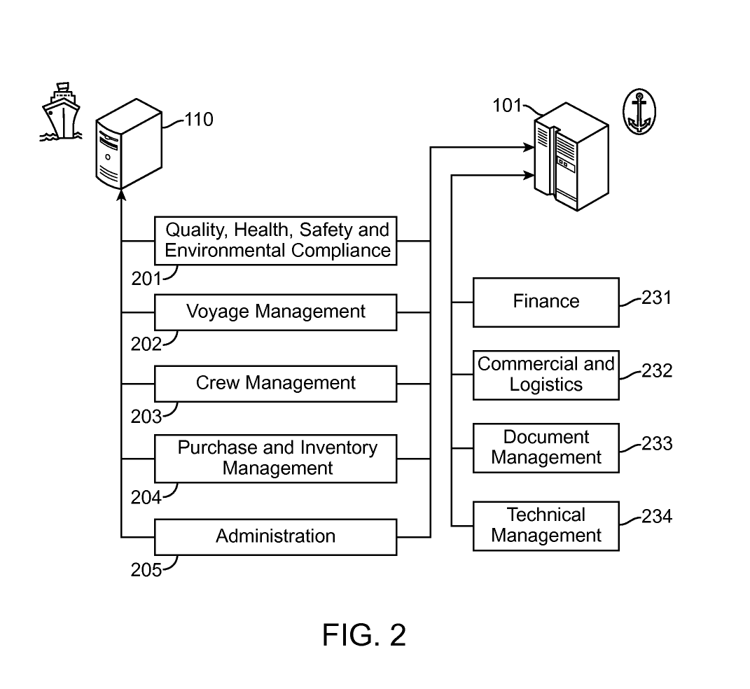

In one embodiment the instances of the vessel management system is made up of workflow-based modules for management of operations of a vessel, as shown in FIG. 2. The modules include a quality, health, safety and environmental compliance module 201, a voyage management module 202, a crew management module 203, a purchase and inventory management module 204, and an administration module 205. As shown in FIG. 2, these modules are present in the system installed and running on both the vessel-based server 110 and the land-based server 101. The land-based server 101 additionally is provided with module for finance management 231, a commercial and logistics module 232, a document management module 233 and a technical management module 234, as illustrated in FIG. 2.

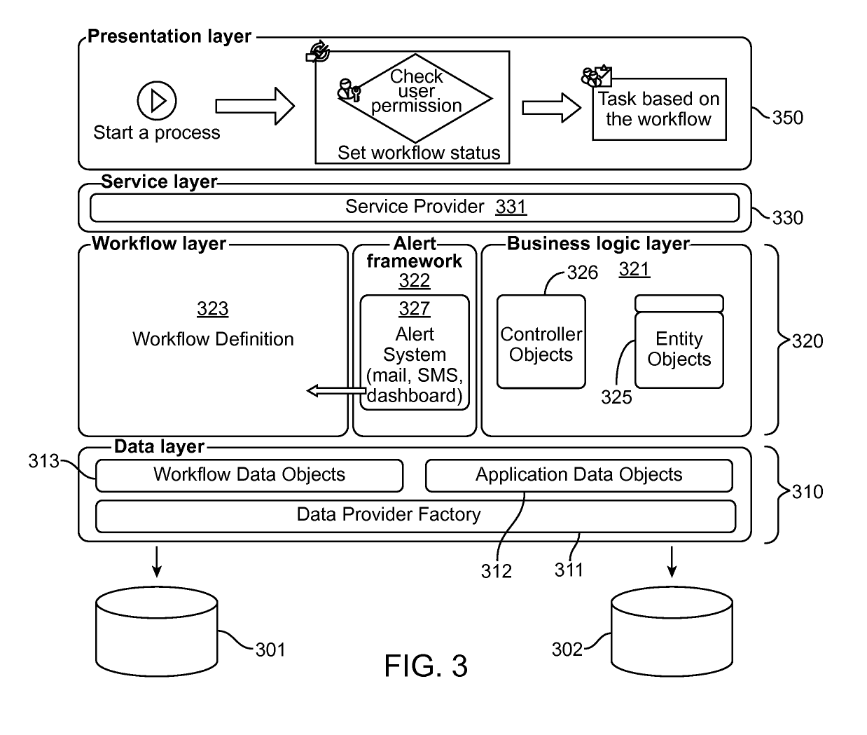

In one embodiment the architecture of the system of the invention is illustrated in FIG. 3. As shown in FIG. 3, the architecture of the system comprises a number of layers, with a data layer 310 at the lowest level, a workflow layer 320 at the next higher level, a service layer 330 above the workflow layer and a presentation layer 350 at the top level. As shown in detail in FIG. 3, the data layer 310 further comprises data provider factory 311, application data objects 312 and workflow data objects 313. The workflow layer 320 comprises a business logic layer 321, an alert framework 322 and a workflow definition layer 323. Service layer 330 comprises service provider 331. At the highest level, the presentation layer 350 comprises logic for receiving a user input, checking user privileges and to initiate a task based on workflow.

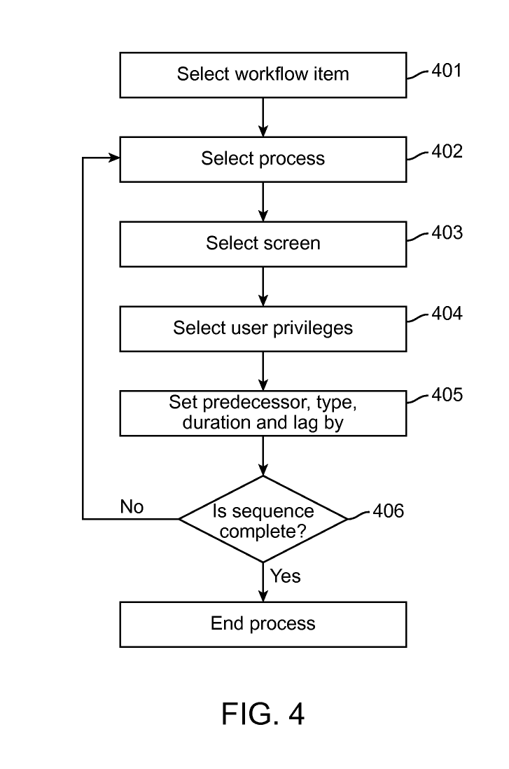

In one embodiment of the invention the modules of the system are configured to provide workflow based functions and communication for performing operations within the vessel and for vessel management, as illustrated in FIG. 4. The workflow definitions are shown in FIG. 4, where when a workflow item is selected or initiated (step 401), the appropriate process in the sequence for the appropriate task is selected (step 402) and the corresponding screen selected (step 403) and user privileges are applied (step 404). The process involves setting appropriate predecessor, type and duration, and lag time for the task (step 405). Finally, the workflow definition logic identifies whether all the tasks associated with the workflow sequence are completed, and if not, proceeds with the cycle from step 402. If the sequence is completed, then the process ends.

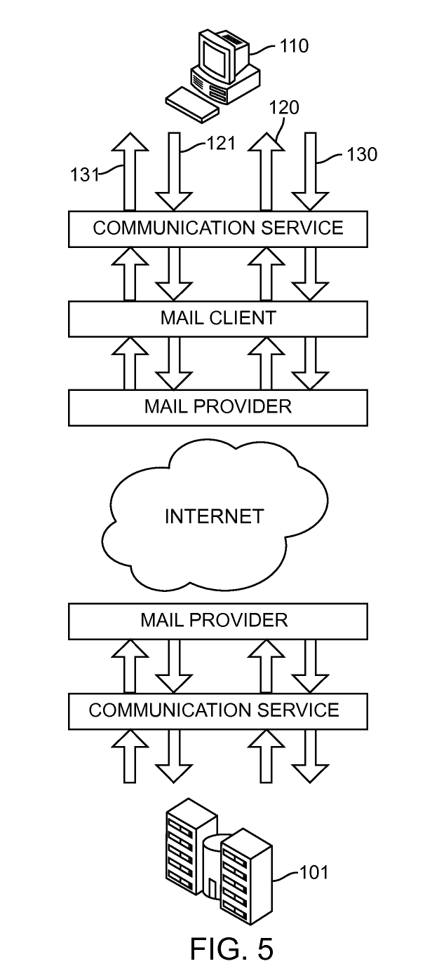

In one embodiment the invention comprises communication architecture as shown in FIG. 5. The land based server 101 and vessel-based server 110 perform the role of sending and receiving data in the form of emails. The communication service instances are configured to run in server 101 as well as in 110. Whenever a data insertion or update request is initiated at the vessel based server 110, the communication service running on server 110 creates a data file and saves the same as draft mail to mail client in the ship side. The mail client pushes the mail as data forward 130 through the mail provider when the satellite connection is established. The mail thus sent is forwarded to the destination mail address via internet, with corresponding update to the database on server 101.

When the mail reaches the destination mail ID, such as server 101 for example, the communication service will read the data sent from the vessel and updates it in the database server at 101. If the operation is completed successfully, an ACK signal or if unsuccessful, a NACK is sent back to the ship (operation 120) which is received at the vessel-based server 110. The communication service at server 110 downloads the message and updates receipt against the data file sent. If the data is sent from server 101, the communication service similarly pushes data file generated via data forward 131 to the vessel's mail box. As with the communication from the vessel side, when synchronized the data file is downloaded and the ACK/NACK file is sent from server 110 to 101, which is updated to the database on the server 101.

In various embodiments illustrated with reference to FIG. 5, the communication system used by the system may comprise a satellite network, a Wi-Fi network, a mobile telephone network or a wired data network, depending on the availability of the network and proximity to a service provider. The system of the invention is configured to efficiently manage the exchange of information while saving operational costs.

In one embodiment the quality, health, safety and environmental compliance module 201 is configured to perform several functions relating to safety such as recording of accidents, near-misses and injuries relating to ship operations. The module is further configured to generate incident reports when required and communicate to the appropriate user level. The module 201 further comprises an audit module for scheduling and conducting quality audits and safety audits. The audits may comprise investigation and analysis of incidents and non-conformances, including assignment of personnel, implementation and review of corrective actions for quality, safety or environmental compliance, as may be required. In one embodiment the system of the invention provides modules for scheduling and review of drills, with record of minutes underlining areas of improvement. The compliance module 201 is further configured to schedule and record minutes of meetings, including communications and follow up alerts on actions from minutes of meeting.

In one embodiment the system of the invention also provides a training module to cater to the various types of training that may be required in a ship or that could be provided on a land-based facility. The training scheduled may be in advance of anticipated requirement, or it could be in response to a review and suggested corrective actions, but in either case, may be minuted in meetings and recorded in the system as a training requirement. As earlier explained with reference to FIG. 2, the QHSE module 201 may include training as corrective action for maintaining quality, for health reasons, to comply with safety regulations or for environmental compliance. Additionally, training is also associated with the crew management module 203.

In various embodiments the QHSE module of the system also includes comprehensive reporting and communications management functions so that schedules are communicated to responsible resources for necessary actions, approvals in advance for routine as well as critical tasks. The reporting capability includes generation of electronic reports suitable for filing with statutory authorities as well as hard copy reports in a flexible manner, as may be required.

In one embodiment of the system the invention provides for a voyage management module 202 to perform functions including scheduling of voyages and logging of voyage details including ship's position. The logging of voyage details may include retrieving data from various sensors and instruments on board the vessel. The voyage details may additionally comprise bunker details indicating fuel storage, ship-generated waste and bilge. The ship-generated waste details may be required to be in compliance with various regulations that may be dependent on the port of call and the jurisdiction. The voyage details also include cargo details such as description, piece count, weights, and hazard classification details, if applicable. The voyage management module is additionally configured to provide reports of bunker details, departures, noon reports, arrivals and geolocation information of one or more vessels as required.

In one embodiment the invention comprises a crew management module 203 configured to record and maintain a crew database, including background, credentials, tracking of sign-on and sign-off dates, contract data, performance appraisal of crew and administering a promotion system based on the appraisal. The system is also configured to provide search and retrieval of crew availability in conjunction with the planning and scheduling functions, including voyage management as detailed with reference to module 202. In addition, the crew management module 203 also comprises a training and repatriation module for follow-up actions based on the performance appraisal results.

The purchase module 204 according to one embodiment of the invention comprises an inventory management module operable with an inventory database, a shopping module configured to handle purchase requests and an ordering module. The ordering module queries a vendor database to obtain suitable vendors, who are then sent enquiries. When the offers are received, they are compared and the statement presented to the purchaser. The module includes options to change the mode of purchase to direct, depending on whether the vendor is pre-qualified or if there is a rate-contract in place, with communications and recording of approvals.

The administration module 205 of the invention, in one embodiment comprises a workflow engine configured to administer user privileges for authorizing transactions and approvals within the system. The system is also configured to provide alerts on follow-up tasks according to the workflow.

The system of the invention in one embodiment also comprises a mobile application based on either the Android™ platform or the iOS™ system. The mobile application is configured to bring to a mobile telephone user customized dashboard and alerts including voyage details, and alerts associated with the privileges based on user permission or role. The mobile application therefore enables personnel to effectively participate in the management of the vessel while ensuring adherence to processes, procedures and deadlines.

In one embodiment the invention is a computer program product that is carried in a non-volatile non-transitory computer-readable memory for performing functions as substantially described in relation to FIGS. 1-6. The program product may be installable in a land based server 101, a vessel based server.

### Example 1

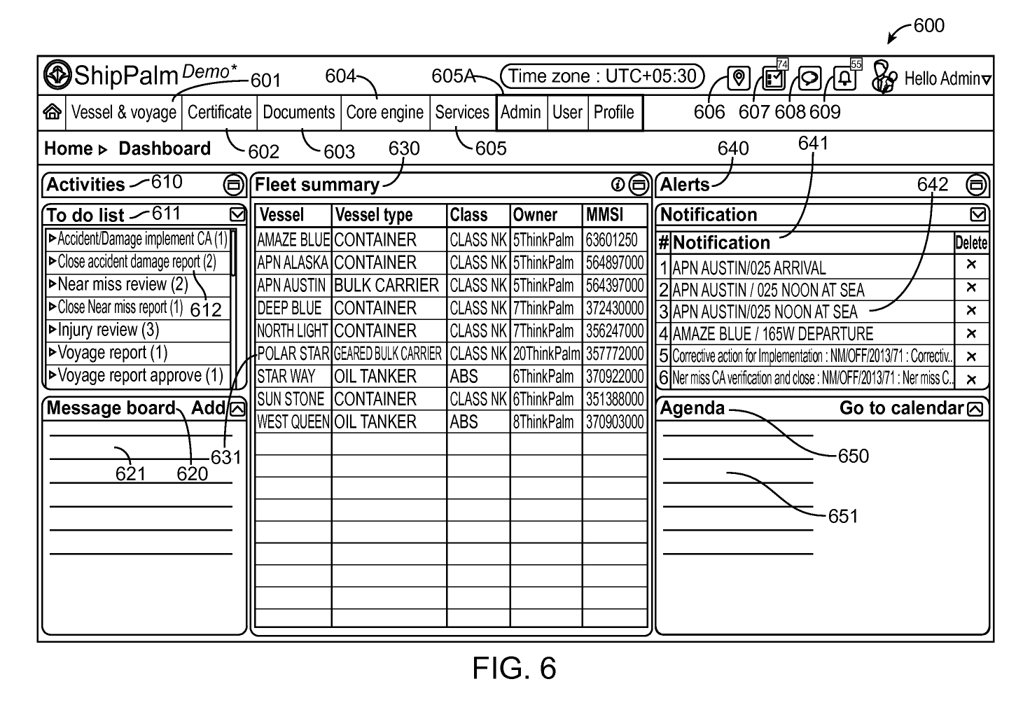

Exemplary implementation of the invention is further illustrated. An example of the instance of the system illustrated in FIGS. 1-5 running in the land-based server 101 (FIG. 1) is further illustrated showing screens of the various modules. The typical dashboard 600 of the system illustrated using a land-based server instance is shown in FIG. 6, comprising on the top of the screen drop down menu items Vessel & Voyage 601, Certificate 602, Documents 603, Core Engine 604, Services 605, and administrative functions 605A, through Admin User and Profile tabs. The dashboard provides access to critical information on fleet management with a series of panels including Activities 610, Message Board 620, Fleet Summary 630, Alerts 640 and Agenda 650.

Activities panel 610 comprises To Do List 611 comprising action items from various modules 201 through 234 illustrated in FIG. 2. As illustrated in FIG. 6, these may comprise corrective actions, voyage reports and review items. Message Board 620 lists notifications and information items 621 from individual vessels. The central Fleet Summary panel 630 lists various vessel names, their type, class, ownership and other details in table 631. Alerts panel 640 carries notifications regarding events such as arrivals, noon reports, implementation of corrective actions etc. 642 in notification panel 641.

The top right hand corner of the dashboard 600 in FIG. 6 provides four buttons 606 to 609, for instant access to information. Button 606 opens a screen showing geolocation of various vessels, while pending activities 607, messages 608 and notifications 609 are accessible as full screens through the respective buttons. The number of new updates since the last user session is shown overlaid on top of the buttons.

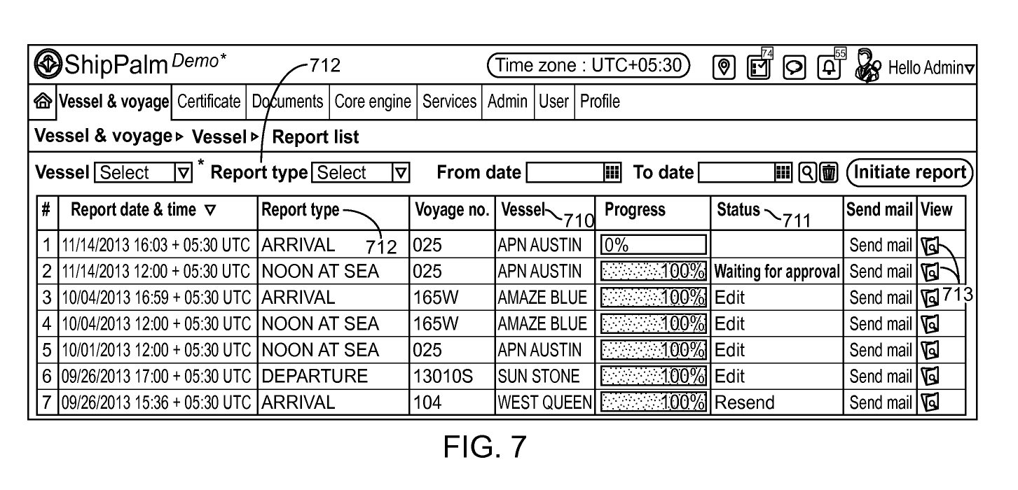

The various functionalities served by the drop down menu items shown in FIG. 6 will now be illustrated with reference to FIGS. 7-12. The Vessel & Voyage report list 611 (FIG. 6) is shown in FIG. 7, wherein the server instance listing reports from various vessels 710 with status 711 and provision to filter by date or report type. The reports pertain to types 712 such as arrival, noon report, departure etc. and link 713 to download for viewing.

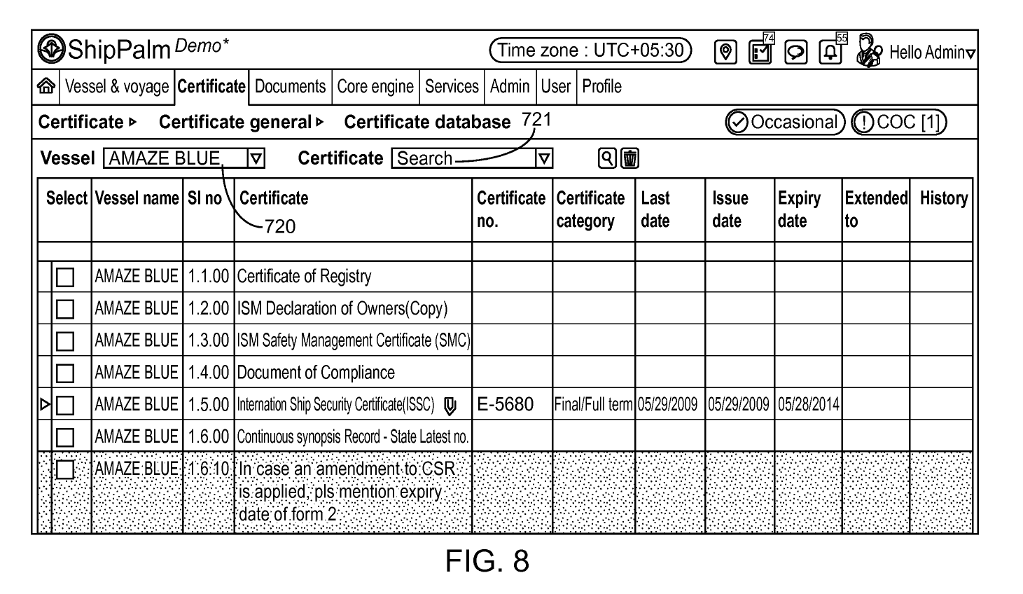

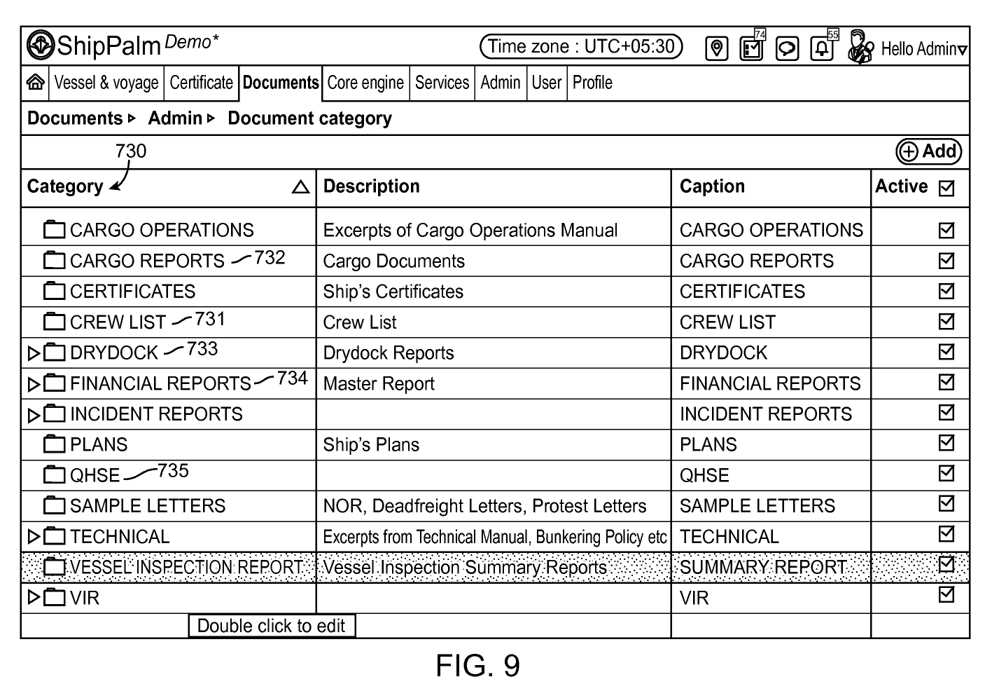

The certificate management component on the server version is shown in FIG. 8, where certificates 602 applicable to a particular vessel could be viewed along with issue, expiry and other important data required for management of renewals from vessel dropdown 720. Alternatively, the certificates could be searched using the certificate type box 721. The document repository 730 accessible through the Documents dropdown 603 of the main screen is shown in FIG. 9, which leads to folders pertaining to various types of reports including crew lists 731, cargo reports 732, drydock 733, financial reports 734 and QHSE reports 735 for the vessels being managed by the system.

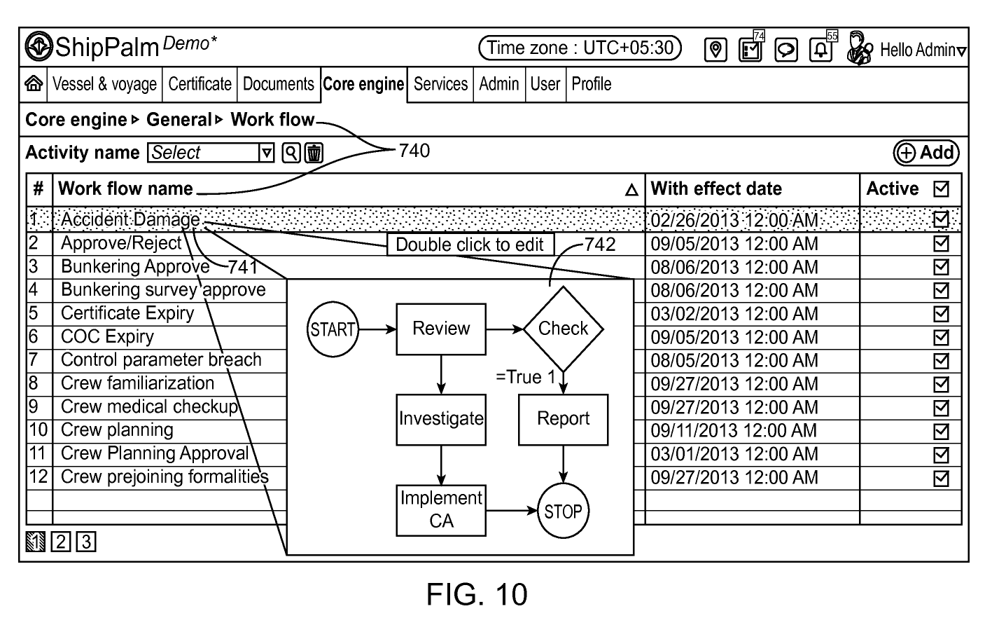

The core workflow components from the Core Engine drop down 604 is illustrated in FIG. 10, where the workflow features or settings 740 for each process is defined. An example definition 742 for Accident Damage assessment 741 is shown in FIG. 10. The workflow definitions are editable so that required functionality could be built into the application. The workflow settings are configured along with user privileges so that tasks relating to the various functions of the system are accomplished effectively, as already explained with reference to FIG. 4 relating to functioning of the workflow system.

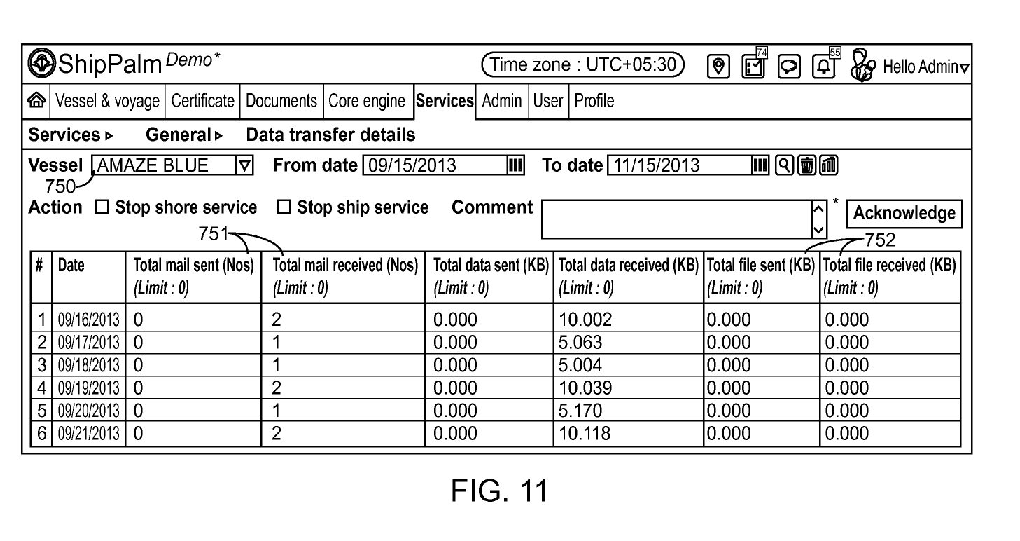

The communication log on server 101 pertaining to a vessel is viewable through the Services drop down 605, as shown in FIG. 11. The vessel drop down 750 allows viewing of mails 751 and file attachments 752 sent and received by date, number, data size, etc. for each vessel selected.

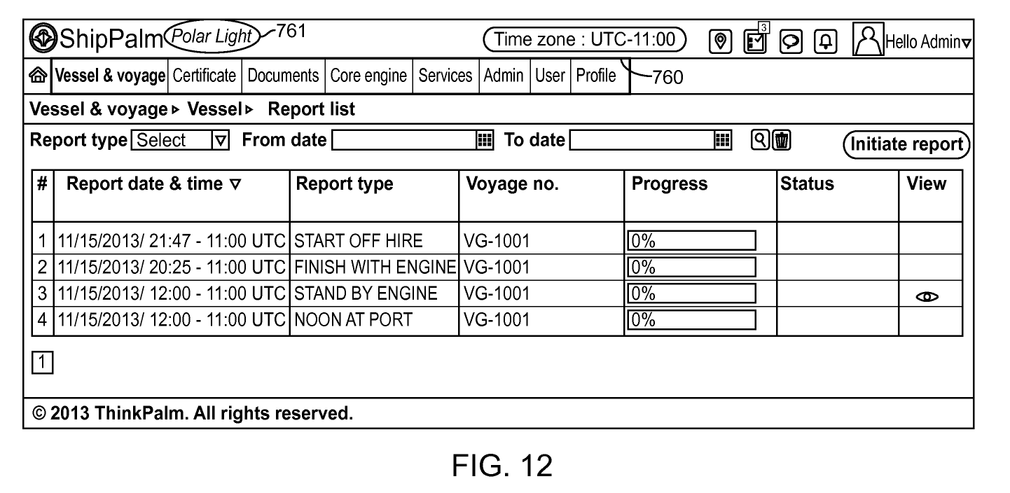

A sample screen on an instance of the system of the invention running on a vessel 110 (FIG. 1) is shown in FIG. 12. The menu items 760 in FIG. 12 correspond to those shown in relation to the server version in FIG. 6, except for Core Engine 604, which only is available on the server instance as illustrated in FIGS. 6-11. The Vessel & Voyage report list in FIG. 12 shows reports pertaining to the specific vessel on which the instance of the system is running, as shown in top left hand corner at location 761. The functionality of all other menu items are the same as illustrated in FIG. 6-9 and FIG. 11, with reference to retrieving and accessing various reports and logs.

Example 1 has illustrated the system of the invention through exemplary implementation via screens detailing the functionalities and capabilities of the invention. However, the example screens shown are by way of exemplary illustration and should not be construed as exhaustive in relation to the full functional capabilities of the system of the invention as claimed further.

While the invention has been disclosed with reference to certain embodiments, it will be understood by those skilled in the art that various changes may be made and equivalents may be substituted without departing from the scope of the invention. In addition, many modifications may be made to adapt to a particular situation or material the teachings of the invention without departing from its scope.

What is claimed is:

1. A system for management of operations of one or more vessels, comprising:
a land-based server coupled to one or more business databases, wherein the business databases comprise business data including financial data and inventory data;
a vessel-based server coupled to one or more sensor modules configured to collect voyage related data; and
a contextual engine coupled to the land-based server and the vessel-based server via a network, wherein the contextual engine is configured to synchronize the voyage data and the business data, and wherein the contextual engine is configured to produce a context specific management framework using the synchronized voyage data and the business data.

2. The system of claim 1, further comprising a regulation server coupled to one or more regulation databases comprising vessel regulation data, docking data and vessel certification data.

3. The system of claim 1, wherein the management framework is presented as a dashboard.

4. The system of claim 1, the vessel-based and land-based servers further comprising workflow-based modules for management of operations of a vessel including:
a quality, health, safety and environmental (QHSE) compliance module;
a voyage management module;
a crew management module;
a purchase and inventory management module; and
an administration module;
wherein the modules are configured to provide workflow based functions and communication through a network.

5. The system of claim 4 wherein the communication is effected via a satellite network, a Wi-Fi network, a mobile telephone network or a wired data network.

6. The system of claim 1, wherein the land-based server further comprises:
a finance module;
a commercial and logistics module;
a document management system; and,
a planned maintenance system, wherein the modules are configured for managing a fleet of vessels.

7. The system of claim 4, wherein the quality, health, safety and environmental compliance module is configured to perform functions comprising:
recording of accidents;
scheduling and recording of audits;
scheduling and reviewing of drills;
scheduling and conducting investigations, including reviewing and implementing corrective actions thereafter;
scheduling and communicating of meetings and capturing minutes thereof;
scheduling of training; and
risk assessment and scenario analysis.

8. The system of claim 7, wherein the quality, health, safety and environmental compliance module, is further configured to perform functions including generating reporting and communication corresponding to each function.

9. The system of claim 4, wherein the voyage module is configured to perform the functions of:
scheduling of voyages;
logging of voyage details including ship's position, bunker details, garbage details and cargo details;
reporting of bunker details, departures, noon reports and arrivals; and
geo-location of one or more ships.

10. The system of claim 4, wherein the crew management module is configured to perform the functions of:
recording and maintaining a crew database;
tracking of sign-on and sign-off dates of crew in the database;
searching and retrieving crew availability data;
maintenance of crew contract data;
recording performance appraisal of crew; and
administering a promotion system based on the appraisal.

11. The system of claim 10 wherein the crew management module further comprises a training and repatriation module for follow up actions based on the appraisal data.

12. The system of claim 4, wherein the purchase module comprises:
a shopping module configured to handle purchase requests;
an inventory management module operable with the inventory database; and
an ordering module operable with a vendor database to send enquiries, receive offers and prepare comparative statements.

13. The system of claim 4, the administration module further comprising:
a workflow engine configured to administer user privileges for authorizing transactions and approvals within the system; and
to provide alerts for follow-up of incomplete tasks according to the workflow.

14. The system of claim 5 further comprising a mobile application configured to provide to a user:
voyage related details;
based on role of the user.

15. A computer program product with program code for management of operations of one or more vessels stored in a non-transitory computer-readable storage medium, comprising:
a contextual engine coupled to a land-based server and a vessel-based server via a network;
wherein the land-based server is coupled to one or more business databases wherein the business databases comprise business data including financial data and inventory data;
wherein the vessel-based server is coupled to one or more sensor modules configured to collect voyage related data; and
wherein the contextual engine is configured to synchronize data between the land based server and the vessel-based server and to produce a context specific management framework using the synchronized voyage data and the business data.

16. The computer program product of claim 15, further comprising workflow-based modules for management of operations of a vessel including:
a quality, health, safety and environmental compliance module;
a voyage management module;
a crew management module;
a purchase and inventory management module; and
an administration module;
wherein the modules are configured to provide workflow based functions and communication through a network.

17. The computer program product of claim 16, wherein the communication is effected via a satellite network, a Wi-Fi network, a mobile telephone network or a wired data network.
